(19) United States
(12) Patent Application Publication
(10) Pub. No.: US 2009/0022849 A1
(43) Pub. Date: Jan. 22, 2009

(54) Prebiotic Use of Fruits and Fruit Juices in the Promotion of Beneficial Gut Microflora

(76) Inventors: Mike Clifford, Surrey (GB); Glenn Gibson, Berkshire (GB); Henglong Hu, Gloucestershire (GB); Andrea Rodig-Penman, Bennekom (NL)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 10/598,760

(22) PCT Filed: Mar. 9, 2005
(86) PCT No.: PCT/EP2005/002701

§ 371 Date: Sep. 27, 2007

(30) Foreign Application Priority Data
Mar. 11, 2004 (GB) 0405540.6

(51) Int. Cl. A23L 1/28; A23L 1/06; A23L 1/36; A23L 2/02

(52) U.S. Cl. 426/61; 426/615; 426/599; 426/629

(57) ABSTRACT

The invention concerns the prebiotic effects of dark fruit and their juices such as blackcurrant, cranberry and pomegranate juices. The invention is also directed to the use of the a dark fruit or dark fruit juice for manufacture of an orally ingestable composition to promote health by promoting the growth of beneficial gut microflora. The beverage can be made from one or more dark fruit juices, in combination with other prebiotics and various other ingredients.

The present invention relates to the prebiotic effects of dark fruit and dark fruit juice and their use in the promotion of growth of beneficial gut microflora.

The human gut microflora comprises more than 500 different species of bacteria that have a great metabolic impact upon human health (Roberfroid et al., Nutrition Reviews 53: 127-130, 1995; Steer et al., Nutrition Research Reviews 13: 229-254, 2000). One important function of the gut microflora, from the host's point of view, is to prevent colonization of potentially pathogenic microorganisms by outcompeting invading pathogens for ecological niches and metabolic substrates. Microbiological metabolism in the gut also serves as an important source of energy for coloncytes and as a source of B vitamins and vitamin K. The gut microflora act as an important modulator of the immune system, not only educating the naïve infant immune system but also serving as an important source of non-inflammatory immune stimulation throughout life in healthy individuals.

The gut microflora can be divided into potentially deleterious and potentially health-promoting species. For example, some Clostridium spp., and proteolytic Bacteriodes spp. are considered potentially harmful because of their association with certain acute and chronic gastrointestinal complaints. Their metabolic end products are toxic and can cause cellular destruction in the bowel. Moreover, some products may enter the bloodstream and exert negative effects systemically. On the other hand, Bifidobacterium spp., and the lactic acid bacteria, particularly Lactobacillus spp. are considered to play an important role in a healthy gut ecosystem through their antagonistic activities towards potential pathogens, immunomodulatory activities, production of short chain fatty acids and reduction of microflora associated enzyme activities involved in the production of carcinogens and gentoxins (Gibson and Roberfroid, Journal of Nutrition 125, 1401-1412 1995; Yaeshima International Journal of Food Microbiology 30: 303-31 1996).

There is currently much interest in the concept of actively managing the colonic microflora with the aim of improving host health. This has been traditionally attempted by the consumption of live microbial food supplements known as probiotics. A probiotic has been defined as ‘a living microbial food ingredient that is beneficial to health’ (Diplock et al., British Journal of Nutrition, 1999). The most well studied and commercially used probiotics are lactobacilli and bifidobacteria. Examples of products containing such probiotics are yoghurts and dairy-based drinks such as Actimel™ (commercially available in the United Kingdom).

An alternative approach is the consumption of other types of food ingredients known as prebiotics. A prebiotic has been defined as ‘a nondigestible food ingredient that beneficially affects the host by selectively stimulating the growth and/or activity of one or a limited number of bacteria in the colon and thus improves host health’ (Gibson and Roberfroid, Journal of Nutrition 125, 1401-1412 1995).

According to Collins & Gibson (American Journal of Clinical Nutrition 1999; 69 (suppl)), for a food ingredient to be classified as a prebiotic, it should:
1. be neither hydrolysed nor absorbed in the upper part of the gastro-intestinal tract;
2. be a selective substrate for one or a limited number of potentially beneficial commensal bacteria in the colon, thus stimulating the bacteria to grow, become metabolically activated, or both; and
3. be able as a consequence to alter the colonic microflora toward a more healthy composition. (Collins & Gibson,).

As such, they fortify indigenous gut flora components that are thought to be of benefit. Known prebiotics are dietary soluble fibres such as inulin, lactulose, fructo-oligosaccharides and galacto-oligosaccharides, which are able to survive the digestion and selectively stimulate the beneficial members of the gut microflora, such as bifidobacteria, in the colon (Gibson et al., New Developments in Functional Foods. Oxford: Chandos Publishing Limited 2000).

US patent application US 2003/0060445 describes nutritional formulations containing prebiotic substances, the substances being a combination of oligofructose and sialyllactose.

WO 02/091833 describes pharmaceutical compositions comprising a probiotic, a prebiotic and an ammoniaphilic urea-degrading microorganism with high alkali pH stability and high urease activity. The prebiotics described are oligosaccharides, inulin, lactulose and other vegetable fibres.

In the current growing health food market, new prebiotic compositions are required for managing gut health.

Dark fruit such as blackcurrant, cranberry and pomegranate are commonly consumed in many countries around the world. Epidemiological studies indicate that a high intake of fruit and vegetables may lower the risks of some chronic diseases (Kant et al., American Journal of Clinical Nutrition, 1993; Hertog et al., Lancet 342: 1007-1011, 1993; Lampe et al., American Journal of Clinical Nutrition, 1999). The fruit are rich in natural antioxidant polyphenolic compounds, such as anthocyanins, proanthocyanins and flavonols. They also contain simple phenols such as cinnamates and hydroxybenzoates and tannins such as ellagitannins, gallagitannins and condensed tannins. Some berry fruit and phenolic compounds within the berries have been reported to have antimicrobial effects (Puupponen-Pimia et al., Journal of Applied Microbiology 90: 494-507, 2001).

Blackcurrant juice is rich in vitamin C, and rich in anthocyanins such as cyanidin-rutinoside, cyanidin-glucoside, delphinidin-rutinoside, and delphinidin-glucoside. The blackcurrant anthocyanins have been found to be bioavailable to humans, but only a small percentage of the intake can be absorbed into the blood and excreted through urine (Rechner et al., Free Radical Research 36: 1229-1241, 2002). Therefore, the majority of ingested anthocyanin is retained in the small and large intestines during the digestion and excretion processes.

Cranberry juice has been suggested to be beneficial in the prevention and treatment of urinary tract infections (Kontiokari et al., British Medical Journal 322: 1-5, 2001) due to its acidifying effects on urine as well as anti-microbial properties.

The consumption of pomegranate juice has been reported in a human study to be beneficial to cardiovascular health (Aviram et al., American Journal of Clinical Nutrition 71: 1062-1076, 2000).

Dark fruit have not previously been described for other health promoting effects. Dark fruit have now been found to have a prebiotic effect. Furthermore, dark fruit have been found to influence the pattern of the gut microflora, with a preferential promotion of the growth of ‘beneficial’ bacteria and concomitant reduction in the growth of ‘harmful’ bacteria.

The observed prebiotic effect thus differs from that of traditional prebiotics such as inulin, because dark fruit not only promote the growth of beneficial bacteria but also suppress the growth of harmful bacteria.

According to the present invention there is provided the use of dark fruit for the promotion of the health of a mammal, characterised in that the dark fruit have a prebiotic effect.

The present invention is directed to methods of improving the health of a mammal, preferably a human by the ingestion of dark fruit. The methods according to the present invention will improve the health of a human by the oral consumption of dark fruit.

For the avoidance of doubt the term dark fruit includes the whole fruit, fruit pulp and fruit juice and mixtures thereof. The prebiotic effect of dark fruit is suitably conferred by the consumption of dark fruit in the form of fruit juice.

In one aspect of the present invention the oral consumption of dark fruit promotes the growth of beneficial gut bacteria.

In another aspect of the present invention the oral consumption of dark fruit promote the growth of beneficial gut bacteria and reduces the growth of harmful bacteria.

In the context of the present invention dark fruit means fruit with black, red or blue skins. Such fruit include for example, blackcurrant, blackberry, strawberry, blueberry, pomegranate, plum, grape, raspberry, cranberry, redcurrant and cherry. Preferred dark fruit are blackcurrant, cranberry and pomegranate.

In the context of the present invention beneficial bacteria means those which do not excrete metabolic products that are detrimental to health. Some beneficial bacteria may produce compounds, like vitamins, which are positive to health. They may also be able to inhibit pathogens and are likely to be saccharolytic.

In the context of the present invention harmful bacteria means those which produce toxic products and may also have the ability to cause cell destruction by invasive capacities. Some toxic products produced by harmful bacteria may act locally in the gut and/or have systemic effects.

The invention may be applied to a wide range of compositions comprising dark fruit. Compositions may be in the form of liquids, semi-solids or solids. Compositions may be dairy-based such as yoghurts. Compositions are suitably in the form of beverages. In the context of this invention, the term beverage encompasses ready to drink liquid forms as well as concentrates and powder formulations for dissolution. Ready to drink beverages may be still or carbonated.

The present invention is particularly suitable for use in ready to drink beverages with from about 1 to 40% (v/v) of single strength dark fruit juice, preferably from about 1 to 30% (v/v) and more preferably from about 1 to 15% (v/v) dark fruit juice.

The present inventors have found that the prebiotic effect of dark fruit is particularly pronounced at low concentrations, from 1 to 20% (v/v) of single strength dark fruit juice.

The present invention is also particularly suitable for fermented and non-fermented dairy-based products such as yoghurts, fromage frais and milk based beverages.

Yoghurts will typically comprise from about 1-20% (v/v) fruit or fruit juice, preferably 1-10% (v/v) fruit or fruit juice.

Dairy-based beverages will typically comprise from about 1-40% (v/v) fruit juice.

For the avoidance of doubt single strength juice means the juice when pressed from mature fruit with neither water removed or added. Standards are set for a range of juices by Association of the Industry of Juices and Nectars from fruits and vegetables of the European Union (AIJN).

Compositions of the present invention may be unsweetened or sweetened with sugar or intense sweeteners such as saccharine, aspartyl phenyl alanyl methyl ester or other non-sugar sweeteners. Compositions may also contain other conventional additives such as flavourings, colourings, stabilisers etc.

Compositions according to the present invention may also contain probiotic and prebiotic mixtures.

Compositions according to the present invention may be prepared by mixing the ingredients according to conventional methods. Solids may be dissolved in water prior to mixing with other components. Typically beverage compositions are pasteurised prior to filling in bottles or cans or other packs or are “in-pack pasteurised” after filling.

Testing for Prebiotic Effects with Faecal Batch Culture Fermentation

Static batch cultures were set up in 100 ml sterile bottles filled with 40 ml pre-reduced sterile medium containing (g/l):

| Ingredients | g/l | |
|---|---|---|
| peptone water | 2 | |
| yeast extract | 2 | |
| Na Cl | 0.1 | |
| K₂HPO₄ | 0.04 | |
| KH₂ PO₄ | 0.04 | |
| Mg SO₄•7H₂O | 0.01 | |
| CaCl₂•2 H₂O | 0.01 | |
| Na HCO₃ | 2 | |
| L-Cysteine HCl | 0.5 | |
| Bile salts | 0.5 | |
| Resazurin | 4 | ml |
| vitamin K₁ | 10 | μl |
| Tween 80 | 2 | ml |
| Hemin | 10 | ml. |

A 10% (w/v) faecal slurry from healthy donors was prepared using pre-reduced 0.1 mol/l phosphate buffered saline (pH 7.0) and then mixed in a stomacher for 120 seconds. Each batch culture was inoculated with 5 ml of the faecal slurry, to give a final concentration of 1% (v/v). 1 ml of L-Cysteine HCl was added to each batch culture to further reduce the medium. Batch cultures were maintained under a headspace of O₂-free N₂ and incubated at 37° C. Triplicate samples (1 ml) were removed after 0, 5, 10 and 24 hours for enumeration of bacteria by FISH (Wang and Gibson, Journal of Applied Bacteriology 75: 373-380, 1993). The initial pH of the culture, once the faecal slurry was added, was 6.0. pH was not controlled during the incubation period.

Static batch culture fermentation was carried out in triplicate to determine the prebiotic capabilities of the fruit juices. Four different concentrations of each juice were tested as shown in tables 1, 2 and 3. The final concentrations were achieved by diluting juice concentrates according to the make up of the concentrates (Blackcurrant juice was 7.30 times concentrated while the cranberry and pomegranate juices were 8.82 and 6.98 times concentrate respectively). The growth of Bifidobacterium was assessed at 0, 10 and 24 hours of culturing. As a positive control with the study model, 1% w/v fructo-oligosaccharides was tested along with the juices. The experimental conditions were set at pH 6. The promotion of Bifidobacterium would be regarded as an indication of a prebiotic effect in this simple but efficient culturing model.

### Results

TABLE 1
Effects of blackcurrant juice on the growth
of bifidobacteria in batch culture

| Blackcurrant | | | | |
|---|---|---|---|---|
| juice (single | | | | |
| strength) | N | 0 h | 10 h | 24 h |
| 3.65% | 3 | 7.47 ± 0.32 | 8.17 ± 0.49* | 8.24 ± 0.44* |
| 7.30% | 3 | 7.51 ± 0.36 | 8.23 ± 0.55* | 8.37 ± 0.44** |
| 14.60% | 3 | 7.60 ± 0.41 | 7.91 ± 0.48* | 7.77 ± 0.42* |
| 29.20% | 3 | 7.40 ± 0.23 | 7.58 ± 0.37 | 7.43 ± 0.68 |

*p < 0.05;
**p < 0.01 compared with those measures at 0 h.
N—number of samples taken in three

TABLE 2
Effects of cranberry juice on the growth
of bifidobacteria in batch culture

| Cranberry | | | | |
|---|---|---|---|---|
| juice (single | | | | |
| strength) | N | 0 h | 10 h | 24 h |
| 4.41% | 3 | 7.78 ± 0.19 | 8.16 ± 0.23 | 8.06 ± 0.27 |
| 8.82% | 3 | 7.64 ± 0.13 | 8.26 ± 0.28* | 8.34 ± 0.35* |
| 17.64% | 3 | 7.35 ± 0.28 | 7.71 ± 0.53 | 7.95 ± 0.39* |
| 35.28% | 3 | 7.34 ± 0.25 | 7.26 ± 0.21 | 7.12 ± 0.25 |

*p < 0.05, compared with those measures at 0 h.

TABLE 3
Effects of pomegranate juice on the growth
of bifidobacteria in batch culture

| Pomegranate | | | | |
|---|---|---|---|---|
| juice (single | | | | |
| strength) | N | 0 h | 10 h | 24 h |
| 3.49% | 3 | 7.49 ± 0.24 | 8.11 ± 0.37* | 8.04 ± 0.38* |
| 6.98% | 3 | 7.50 ± 0.29 | 8.42 ± 0.36* | 8.28 ± 0.51 |
| 13.96% | 3 | 7.68 ± 0.16 | 8.38 ± 0.40* | 8.32 ± 0.55 |
| 27.92% | 3 | 7.44 ± 0.28 | 8.19 ± 0.30* | 8.09 ± 0.56 |

*p < 0.05, compared with those measures at 0 h.

Testing for Prebiotic Effect with a Model of the Human Colonic Microflora (Gut Model Design)

The continuous culture system consisted of 3 vessels, V1, V2 and V3. V1 had an operating volume of 280 ml and the other two of 300 ml. This in vitro model has been designed to mimic the three major regions of the human colon: proximal, transverse and distal colon respectively. Temperature (37° C.) and pH were automatically controlled. Culture pH in the vessels was 5.5 in V1, 6.2 in V2 and 6.8 in V3. Each fermenter was magnetically stirred and the growth medium continuously sparged with oxygen-free nitrogen (15 ml/min) and fed from a glass medium reservoir by a peristaltic pump to V1. V1 sequentially supplied V2 and V3 via an overflow and a series of weirs. The overflow from V3 was led to a waste container.

The culture medium had the following constituents dissolved in distilled water (Macfarlane et al., FEMS Microbiology Ecology 26: 231-243, 1998):

| Ingredient | g/l | |
|---|---|---|
| Starch (Sigma, Poole, Dorset, UK) | 5.0 | |
| Pectin (citrus) | 2.0 | |
| Guar gum | 1.0 | |
| Mucin (porcine gastric type III) | 4.0 | |
| Xylan (oatspelt) | 2.0 | |
| Arabinogalactan (larch wood) | 2.0 | |
| Inulin | 1.0 | |
| Casein (Sigma, Poole, Dorset, UK) | 3.0 | |
| Peptone water | 5.0 | |
| Tryptone | 5.0 | |
| Bile salts No3 | 0.4 | |
| Yeast extract | 4.5 | |
| NaCl | 4.5 | |
| KCl | 4.5 | |
| FeSO₄•7H₂O | 0.005 | |
| KH₂PO₄ | 0.5 | |
| MgSO₄•7H₂O | 1.25 | |
| CaCl₂• 6H₂O | 0.15 | |
| NaHCO₃ | 1.5 | |
| L-Cysteine-HCl | 0.8 | |
| Hemin | 0.05 | |
| Tween 80 | 1.0 | |
| Vitamin K | 10 | μl |
| Resazurin | 4 | ml |

The medium was autoclaved at 121° C. for 15 minutes and placed under nitrogen gas whilst hot.

To inoculate the system, fresh faecal samples were obtained from healthy human subjects who reported no antibiotic usage during the previous 6 months and had no history of gastrointestinal disorder. A 20% (w/v) slurry was prepared using anaerobic phosphate buffered saline and approximately 100 ml added to each culture vessel. The system was operated at a retention time (R) of 43 h as calculated as the reciprocal of the dilution rate. The fermentation system was allowed to equilibrate overnight before the pump was started.

### Gut Model Dosing and Sampling Regime

Samples were taken at day −10 (before equilibration, ten day before dosing with juices), Day −2, −1 and 0 (to have an average of the last 3 days of the control period as baseline). After this period of 10 days, the medium was changed to 0.814% (w/v) carbohydrate (0.407% starch, 0.1628% Xylan, 0.1628% arabinogalactan, and 0.0814% inulin, all as w/v)) and fruit juice was added twice (every 12 hours—based on a flow rate from the reservoir of 20 ml/h) daily. A concentration of 5% single strength juice was maintained in the flow through the system so that the initial dose of the concentrate into V1 was slightly higher. Samples were taken again at day 10, 11, 12 and then day 20, 21, 22.

### Results

The promotion of the growth of beneficial bacteria such as bifidobacteria and lactobacilli and/or inhibition of the growth of the deleterious bacteria such as bacteroides and clostridia would be regarded as a prebiotic effect. From the Tables 4-6, these effects have been clearly demonstrated.

Bacterial numbers present in the gut model treated with fruit juice concentrate are expressed as Log₁₀ cells/ml gut model +/− standard deviation. Mean values were generated from samples taken on three consecutive days.

TABLE 4
Bacterial numbers in gut model dosed with blackcurrant juice concentrate

| | | | | | | | |
|---|---|---|---|---|---|---|---|
| Vessel | Total bacteria | Bacteroides spp. | Bifidobacteria | C. histolytocum | Lactobacilli | E. rectale | E. limnosum |

V1

| | | | | | | | |
|---|---|---|---|---|---|---|---|
| T0 | 9.62 ± 0.08 | 8.90 ± 0.15 | 8.20 ± 0.06 | 7.49 ± 0.07 | 7.63 ± 0.10 | 8.89 ± 0.10 | 6.98 ± 0.08 |
| T10 | 9.77 ± 0.07** | 7.72 ± 0.03** | 8.68 ± 0.05* | 7.13 ± 0.08* | 7.65 ± 0.12 | 9.18 ± 0.04* | 7.31 ± 0.05 |
| T20 | 9.98 ± 0.16⁺⁺ | 6.98 ± 0.10**⁺⁺ | 8.44 ± 0.02*⁺ | 7.10 ± 0.11* | 7.78 ± 0.04 | 9.17 ± 0.08 | 7.64 ± 0.20 |

V2

| | | | | | | | |
|---|---|---|---|---|---|---|---|
| T0 | 9.54 ± 0.07 | 8.46 ± 0.07 | 8.03 ± 0.09* | 7.23 ± 0.10 | 7.62 ± 0.05 | 8.73 ± 0.09 | 7.33 ± 0.13 |
| T10 | 9.54 ± 0.08 | 8.47 ± 0.08 | 8.48 ± 0.03 | 6.93 ± 0.07* | 7.62 ± 0.11 | 9.02 ± 0.03* | 7.78 ± 0.06 |
| T20 | 9.76 ± 0.11 | 8.45 ± 0.09 | 8.36 ± 0.09* | 6.69 ± 0.11 | 7.84 ± 0.05 | 9.12 ± 0.10 | 7.55 ± 0.01⁺ |

V3

| | | | | | | | |
|---|---|---|---|---|---|---|---|
| T0 | 9.59 ± 0.07 | 8.51 ± 0.06 | 8.34 ± 0.04 | 7.26 ± 0.20 | 7.45 ± 0.05 | 8.77 ± 0.06 | 7.07 ± 0.06 |
| T10 | 9.64 ± 0.07 | 8.31 ± 0.09 | 8.57 ± 0.13 | 7.11 ± 0.20 | 7.56 ± 0.11 | 8.98 ± 0.06 | 7.42 ± 0.12 |
| T20 | 9.64 ± 0.07 | 8.13 ± 0.15* | 8.45 ± 0.02 | 6.36 ± 0.09*⁺ | 7.84 ± 0.16 | 9.10 ± 0.22 | 7.23 ± 0.04 |

*P < 0.05,
**P < 0.01 comparing values at T10 and T20 to those at T0
⁺P < 0.05,
⁺⁺P < 0.01 comparing values T20 to those at T10

TABLE 5
Bacterial numbers in gut model dosed with cranberry juice concentrate.

| | | | | | | | |
|---|---|---|---|---|---|---|---|
| Vessel | Total bacteria | Bacteroides spp. | Bifidobacteria | C. histolytocum | Lactobacilli | E. rectale | E. limnosum |

V1

| | | | | | | | |
|---|---|---|---|---|---|---|---|
| T0 | 9.64 ± 0.08 | 9.06 ± 0.28 | 8.31 ± 0.02 | 7.56 ± 0.16 | 6.09 ± 0.04 | 9.13 ± 0.01 | 7.43 ± 0.12 |
| T10 | 9.66 ± 0.03 | 6.42 ± 0.04** | 8.39 ± 0.11 | 7.27 ± 0.36 | 6.14 ± 0.17 | 9.22 ± 0.04 | 7.62 ± 0.15 |
| T20 | 9.75 ± 0.06* | 6.57 ± 0.28** | 8.52 ± 0.05* | 7.23 ± 0.56 | 6.11 ± 0.22 | 9.18 ± 0.06 | 7.88 ± 0.08⁺ |

V2

| | | | | | | | |
|---|---|---|---|---|---|---|---|
| T0 | 9.50 ± 0.08 | 8.86 ± 0.06 | 8.12 ± 0.18 | 7.58 ± 0.07 | 6.39 ± 0.07 | 9.08 ± 0.06 | 7.36 ± 0.15 |
| T10 | 9.67 ± 0.05 | 8.45 ± 0.04** | 8.41 ± 0.09 | 6.87 ± 0.37 | 6.12 ± 0.37 | 9.13 ± 0.24 | 7.55 ± 0.19 |
| T20 | 9.71 ± 0.05 | 8.60 ± 0.04* | 8.47 ± 0.05 | 7.08 ± 0.31 | 6.40 ± 0.31 | 9.14 ± 0.15* | 7.80 ± 0.12 |

V3

| | | | | | | | |
|---|---|---|---|---|---|---|---|
| T0 | 9.32 ± 0.07 | 8.54 ± 0.09 | 8.02 ± 0.1 | 7.56 ± 0.04 | 6.64 ± 0.13 | 8.97 ± 0.07 | 7.19 ± 0.20 |
| T10 | 9.73 ± 0.06** | 8.43 ± 0.10 | 8.41 ± 0.113** | 6.74 ± 0.18* | 6.40 ± 0.15 | 9.09 ± 0.05 | 7.61 ± 0.07 |
| T20 | 9.64 ± 0.05* | 8.50 ± 0.09 | 8.53 ± 0.04* | 6.83 ± 0.18* | 6.76 ± 0.14 | 9.11 ± 0.06 | 7.79 ± 0.09 |

*P < 0.05,
**P < 0.01 comparing values at T10 and T20 to those at T0
⁺P < 0.05,
⁺⁺P < 0.01 comparing values T20 to those at T10

TABLE 6
Bacterial numbers in gut model dosed with pomegranate juice concentrate.

| | | | | | | | |
|---|---|---|---|---|---|---|---|
| Vessel | Total bacteria | Bacteroides spp. | Bifidobacteria | C. histolytocum | Lactobacilli | E. rectale | E. limnosum |

V1

| | | | | | | | |
|---|---|---|---|---|---|---|---|
| T0 | 9.72 ± 0.04 | 9.03 ± 0.05 | 8.32 ± 0.06 | 7.17 ± 0.06 | 6.09 ± 0.04 | 9.07 ± 0.10 | 7.25 ± 0.06 |
| T10 | 9.63 ± 0.05 | 8.92 ± 0.05* | 8.35 ± 0.12 | 6.98 ± 0.35 | 6.45 ± 0.07* | 8.99 ± 0.02 | 7.48 ± 0.10 |
| T20 | 9.67 ± 0.10 | 8.72 ± 0.09 | 8.45 ± 0.05** | 6.63 ± 0.09* | 6.40 ± 0.15 | 9.25 ± 0.02⁺⁺ | 7.76 ± 0.13⁺ |

V2

| | | | | | | | |
|---|---|---|---|---|---|---|---|
| T0 | 9.39 ± 0.02 | 8.85 ± 0.04 | 8.32 ± 0.05 | 6.96 ± 0.14 | 6.37 ± 0.01 | 8.97 ± 0.14 | 7.25 ± 0.06 |
| T10 | 9.50 ± 0.07 | 8.80 ± 0.11 | 8.34 ± 0.12 | 6.72 ± 0.25 | 6.41 ± 0.13 | 9.13 ± 0.03 | 7.62 ± 0.12* |
| T20 | 9.56 ± 0.05⁺ | 8.67 ± 0.11 | 8.70 ± 0.05*⁺ | 6.78 ± 0.06 | 6.32 ± 0.14 | 9.18 ± 0.04 | 7.80 ± 0.10*⁺ |

V3

| | | | | | | | |
|---|---|---|---|---|---|---|---|
| T0 | 9.60 ± 0.03 | 8.67 ± 0.04 | 8.37 ± 0.02 | 6.95 ± 0.07 | 6.30 ± 0.08 | 9.01 ± 0.09 | 7.22 ± 0.06 |
| T10 | 9.49 ± 0.15 | 8.76 ± 0.02 | 8.42 ± 0.07 | 6.61 ± 0.19 | 6.48 ± 0.09* | 8.98 ± 0.07 | 7.58 ± 0.10* |
| T20 | 9.58 ± 0.03 | 8.67 ± 0.04 | 8.77 ± 0.05*⁺ | 6.58 ± 0.05** | 6.69 ± 0.10* | 9.08 ± 0.08 | 7.77 ± 0.08**⁺⁺ |

*P < 0.05,
**P < 0.01 comparing values at T10 and T20 to those at T0
⁺P < 0.05,
⁺⁺P < 0.01 comparing values T20 to those at T10

The positive prebiotic effects observed in blackcurrant, cranberry, and pomegranate juices are illustrative of effects likely to be obtained with other dark fruit.

The invention is illustrated by way of the following non-limiting examples.

### EXAMPLE 1

### Blackcurrant Juice Based Drink

A drink containing blackcurrant juice 1-30% (v/v) single strength juice, optionally in combination with other juices such as apple juice, grape juice, or orange juice. The drink may also contain added ascorbic acid 0.27% w/w, calcium carbonate 0.24% w/w, aspartame 0.17% w/w, blackcurrant flavour 0.12% w/w, potassium sorbate 0.08% w/w, asesulfame K 0.06% w/w, sodium bisulphite 0.14% w/w, colour from grapeskin 0.00002% w/w, and water if this is not a 100% juice drink. The drink may also contain added carbohydrate e.g. glucose syrup. The drink may be still or carbonated.

### EXAMPLE 2

### Cranberry Juice Based Drink

A drink containing 1-40% v/v single strength juice of cranberry juice, optionally in combination with other juices such as apple juice or orange juice. The drink may also contain added carbohydrate e.g. sucrose 10% w/w, ascorbic acid 0.05% w/w, cranberry flavour 0.02% w/w, and preservatives e.g. potassium sorbate or sodium benzoate and water. The product may be still or carbonated.

### EXAMPLE 3

### Pomegranate Juice Based Drink

A drink containing 1-100% v/v single strength juice pomegranate juice, optionally in combination with other juices such as apple juice or orange juice. The drink may also contain added ascorbic acid 0.05% w/w, carbohydrate e.g. glucose or sucrose, aspartame or acesulfame K and water. The drink may be still or carbonated.

### EXAMPLE 4

### Blackcurrant Juice & Dairy-Based Drink

A drink containing 1-20% v/v ssj of blackcurrant juice, optionally in combination with other juices such as apple juice or grape juice. The drink will contain dairy component(s) yoghurt 5% w/w and cream 2% w/w. The drink may also contain added carbohydrate e.g. sucrose 10% w/w, ascorbic acid 0.05% w/w, blackcurrant flavour 0.02% w/w, preservative potassium sorbate and water.

1. A method of promoting the growth of beneficial bacteria in the gut of a human in need thereof, which comprises administering to said human a composition comprising an effective amount of a dark fruit selected from blackcurrant, blackberry, strawberry, blueberry, pomegranate, plum, grape, raspberry, cranberry, redcurrant, cherry or a mixture of two or more thereof as a prebiotic.

2. The method according to claim 1 wherein the dark fruit is in the form of fruit juice.

3. (canceled)

4. The method according to claim 1 wherein the dark fruit is blackcurrant, cranberry, pomegranate or a mixture of two or more thereof.

5. The method according to claim 1 wherein the composition is a beverage.

6. The method according to claim 5 wherein the composition is a beverage concentrate comprising 1-40% (v/v) single strength fruit juice.

7. The method according to claim 5 wherein the composition is ready to drink beverage comprising 1-20% (v/v) single strength fruit juice.

8. The method according to claim 1 wherein the composition further comprises a probiotic.

9. The method according to claim 1 wherein the composition is in the form of a liquid, a semi-solid or a solid.

10. A method of reducing the growth of harmful bacteria in the gut of a human in need thereof, which comprises administering to said human a composition comprising an effective amount of a dark fruit selected from blackcurrant, blackberry, strawberry, blueberry, pomegranate, plum, grape, raspberry, cranberry, redcurrant, cherry or a mixture of two or more thereof as a prebiotic.
